(19) United States
(12) Patent Application Publication
(10) Pub. No.: US 2020/0035989 A1
(43) Pub. Date: Jan. 30, 2020

(54) METHOD FOR PRODUCING ELECTRODE FOR SOLID-STATE BATTERIES

(71) Applicant: TOYOTA JIDOSHA KABUSHIKI KAISHA, Toyota-shi (JP)

(72) Inventors: Norihiro Ose, Sunto-gun (JP); Tomoya Suzuki, Seto-shi (JP); Hajime Hasegawa, Susono-shi (JP); Kazuo Yaso, Susono-shi (JP); Hideaki Nishimura, Sunto-gun (JP); Yuki Matsushita, Nagoya-shi (JP)

(73) Assignee: TOYOTA JIDOSHA KABUSHIKI KAISHA, Toyota-shi (JP)

(21) Appl. No.: 16/519,095

(22) Filed: Jul. 23, 2019

(30) Foreign Application Priority Data
Jul. 27, 2018 (JP) 2018-141537

(51) Int. Cl. H01M 4/13; H01M 4/36; H01M 10/0525; H01M 10/0562; H01M 10/058

(52) U.S. Cl. CPC H01M 4/13; H01M 4/366; H01M 10/058; H01M 10/0562; H01M 10/0525

(57) ABSTRACT

Provided is a method for producing an electrode for solid-state batteries, which comprises a PTC resistor layer and in which electronic resistance is low. The production method is a method for producing an electrode for solid-state batteries, wherein the method is a method for producing an electrode for use in a solid-state battery comprising a cathode, an anode and an electrolyte layer disposed between the cathode and the anode; wherein the electrode is at least one of the cathode and the anode, and the electrode comprises a current collector, an electrode active material layer and a PTC resistor layer disposed between the current collector and the electrode active material layer.

### TECHNICAL FIELD

The disclosure relates to a method for producing an electrode for solid-state batteries.

### BACKGROUND

In a battery used as an in-vehicle power source or as a power source for notebook PCs and portable devices, in the case of misuse such as an internal short circuit or overcharging, the temperature of the whole battery may increase and may have adverse effects on the battery itself or on a device using the battery.

As a measure to prevent such misuse, a technique of using an electrode has been attempted, the electrode comprising a positive temperature coefficient (PTC) resistor layer which has electron conductivity at normal temperature and which shows a rapid increase in electronic resistance value when the temperature of the battery is increased by the misuse.

Patent Literature 1 discloses an all-solid-state battery comprising: a cathode layer comprising a cathode active material layer and a cathode current collector; an anode layer comprising an anode active material layer and an anode current collector; and a solid electrolyte layer disposed between the cathode active material layer and the anode active material layer, wherein the all-solid-state battery further comprises a PTC film between the cathode current collector and the cathode active material layer and/or between the anode current collector and the anode active material layer, and the PTC film contains a conductive material and a resin.

Patent Literature 2 discloses an all-solid-state state battery comprising a laminate of a cathode active material layer, a solid electrolyte layer, and an anode active material layer in this order, and a restraining member that applies a restraining pressure to the laminate in a laminated direction, wherein a PTC layer containing a conductive material, an insulating inorganic substance and a polymer, is disposed at least at one of a position between the cathode active material layer and a cathode current collecting layer for collecting electrons of the cathode active material layer, and a position between the anode active material layer and an anode current collecting layer for collecting electrons of the anode active material layer, and the content of the insulating inorganic substance in the PTC layer is 50 volume % or more.

Patent Literature 3 discloses a battery comprising laminated unit cells, wherein the unit cells each have: a pair of current collectors disposed at opposing ends in the laminating direction, and at least one electrode body disposed between the pair of current collectors, the at least one electrode body including an active material layer of a first electrode and an active material layer of a second electrode different from the first electrode, and a solid electrolyte layer disposed between the first and second electrode active material layers; wherein the pair of current collectors are in contact with the first electrode active material layer or the second electrode active material layer; and the battery further comprises heat-absorbing layers containing a heat-absorbing material and being disposed between the unit cells adjacent to each other in the laminating direction. Also, Patent Literature 3 describes that a PPTC layer may be disposed on the active material layer-side surface of the current collectors.
Patent Literature 1: Japanese Patent Application Laid-Open (JP-A) No. 2017-130283
Patent Literature 2: JP-A No, 2018-014286
Patent Literature 3: JP-A No. 2018-010848

However, the following new problem was found as a result of research: electronic resistance is high in an electrode comprising a PTC resistor layer.

### SUMMARY

The disclosed embodiments were achieved in light of the above circumstance. An object of the disclosed embodiments is to provide a method for producing an electrode for solid-state batteries, which comprises a PTC resistor layer and in which electronic resistance at normal temperature is low. Another object of the disclosed embodiments is to provide a method for producing a solid-state battery.

In a first embodiment, there is provided a method for producing an electrode for solid-state batteries, wherein the method is a method for producing an electrode for use in a solid-state battery comprising a cathode, an anode and an electrolyte layer disposed between the cathode and the anode; wherein the electrode is at least one of the cathode and the anode, and the electrode comprises a current collector, an electrode active material layer and a PTC resistor layer disposed between the current collector and the electrode active material layer; wherein the production method comprises: forming the PTC resistor layer by applying a slurry containing an electroconductive material and a polymer to at least one of both surfaces of the current collector and drying the applied slurry, pressing the current collector on which the PTC resistor layer is formed, at a maximum pressure a1 (pressing A1), pressing an electrode active material member comprising at least the electrode active material layer and excluding the PTC resistor layer, at a maximum pressure b (pressing B), and obtaining the electrode for solid-state batteries by laminating the current collector on which the PTC resistor layer is formed and the electrode active material member so that the PTC resistor layer and the electrode active material layer are in contact with each other; and wherein the maximum pressure applied in the pressing B and the maximum pressure applied in the pressing A1 satisfy the following relation: b>a1.

In the first embodiment, the maximum pressure a1 may be from 199 MPa to 795 MPa.

In a second embodiment, there is provided a method for producing an electrode for solid-state batteries, wherein the method is a method for producing an electrode for use in a solid-state battery comprising a cathode, an anode and an electrolyte layer disposed between the cathode and the anode; wherein the electrode is at least one of the cathode and the anode, and the electrode comprises a current collector, an electrode active material layer and a PTC resistor layer disposed between the current collector and the electrode active material layer; wherein the production method comprises: forming the PTC resistor layer by applying a slurry containing an electroconductive material and a polymer to at least one of both surfaces of the current collector and drying the applied slurry, pressing an electrode active material member comprising at least the electrode active material layer and excluding the PTC resistor layer, at a maximum pressure b (pressing B), obtaining an electrode precursor by laminating the current collector on which the PTC resistor layer is formed and the electrode active material member so that the PTC resistor layer and the electrode active material layer are in contact with each other, and pressing the electrode precursor at a maximum pressure a2 to obtain the electrode for solid-state batteries (pressing A2), and wherein the maximum pressure applied in the pressing 13 and the maximum pressure applied in the pressing A2 satisfy the following relation: b>a2.

In the second embodiment, the maximum pressure a2 may be from 20 MPa to 710 MPa.

In the disclosed embodiments, in the forming of the PTC resistor layer, the slurry may contain an insulating inorganic substance.

In the disclosed embodiments, the insulating inorganic substance may be a metal oxide.

In the disclosed embodiments, the electroconductive material may be carbon black.

According to the disclosed embodiments, the method for producing the electrode for solid-state batteries which comprises a PTC resistor layer and in which electronic resistance at normal temperature is low, can be provided.

### BRIEF DESCRIPTION OF THE DRAWINGS

In the accompanying drawings,

FIG. 1 is a schematic view of an electrode for solid-state batteries obtained by the production method of the disclosed embodiments;

FIG. 2 is a schematic view of the production process of the first embodiment;

FIG. 3 is a schematic view of the production process of the second embodiment;

FIG. 4 is a schematic view of the structure of a sample electrode electronic resistance measurement used in “Examples”;

FIG. 5 is a view showing a relationship between the electronic resistance values of samples for electrode electronic resistance measurement and the electronic resistance values of solid-state batteries comprising the electrodes;

FIG. 6 is a schematic view of an example of the structure of a solid-state battery comprising the electrode obtained by the production method of the disclosed embodiments; and

FIG. 7 is a schematic view of an example of the structure of a solid-state battery comprising the electrode obtained by the production method of the disclosed embodiments and a confining member.

### DETAILED DESCRIPTION

The method for producing the electrode for solid-state batteries according to the first embodiment, is a method for producing an electrode for solid-state batteries, wherein the method is a method for producing an electrode for use in a solid-state battery comprising a cathode, an anode and an electrolyte layer disposed between the cathode and the anode; wherein the electrode is at least one of the cathode and the anode, and the electrode comprises a current collector, an electrode active material layer and a PTC resistor layer disposed between the current collector and the electrode active material layer; wherein the production method comprises: forming the PTC resistor layer by applying a slurry containing an electroconductive material and a polymer to at least one of both surfaces of the current collector and drying the applied slurry, pressing the current collector on which the PTC resistor layer is formed, at a maximum pressure a1 (pressing A1), pressing an electrode active material member comprising at least the electrode active material layer and excluding the PTC resistor layer at a maximum pressure b (pressing B), and obtaining the electrode for solid-state batteries by laminating the current collector on which the PTC resistor layer is formed and the electrode active material member so that the PTC resistor layer and the electrode active material layer are in contact with each other; and wherein the maximum pressure applied in the pressing B and the maximum pressure applied in the pressing A1 satisfy the following relation: b>a1.

The method for producing the electrode for solid-state batteries according to the second embodiment, is a method for producing an electrode for solid-state batteries; wherein the method is a method for producing an electrode for use in a solid-state battery comprising a cathode, an anode and an electrolyte layer disposed between the cathode and the anode; wherein the electrode is at least one of the cathode and the anode, and the electrode comprises a current collector, an electrode active material layer and a PTC resistor layer disposed between the current collector and the electrode active material layer; wherein the production method comprises: forming the PTC resistor layer by applying a slurry containing an electroconductive material and a polymer to at least one of both surfaces of the current collector and drying the applied slurry, pressing an electrode active material member comprising at least the electrode active material layer and excluding the PTC resistor layer, at a maximum pressure b (pressing B), obtaining an electrode precursor by laminating the current collector on which the PTC resistor layer is formed and the electrode active material member so that the PTC resistor layer and the electrode active material layer are in contact with each other, and pressing the electrode precursor at a maximum pressure a2 to obtain the electrode for solid-state batteries (pressing A2); and wherein the maximum pressure applied in the pressing B and the maximum pressure applied in the pressing A2 satisfy the following relation: b>a2.

For the coating layer containing the polymer and the electroconductive material, it is known that when the temperature of the layer exceeds the melting point of the polymer by heating, the layer shows a PTC resistor function (a rapid increase in electronic resistance). This is because, due to the expansion of the polymer, the particles of the electroconductive material, which are in contact with each other, are separated and result in blocking of electron transfer.

In the current collector coated with the PTC resistor layer containing the polymer and the electroconductive material, when heat is generated in the battery due to overcharging or a short circuit, electron transfer from the electrode active material to the current collector is blocked, and an electrochemical reaction is arrested. Accordingly, further heat generation is suppressed and makes it possible to prevent adverse effects on the battery itself and on a device using the battery.

For the PTC resistor layer containing the polymer and the electroconductive material, the polymer is deformed and/or fluidized in such a misuse condition that a short circuit occurs while pressure is applied to the battery, whereby the PTC resistor layer cannot maintain its structure and may fail to exert the PTC resistor function. Accordingly, for the purpose of allowing the PTC resistor layer to maintain its layer structure even when pressure is applied to the battery during overheating, a technique in which an insulating inorganic substance is incorporated in the PTC resistor layer containing the polymer and the electroconductive material, was proposed (Patent Literature 2).

It was thought that in such a PTC resistor layer, electronic resistance inside the PTC resistor layer at normal temperature is increased, thereby increasing electronic resistance in the whole electrode.

However, as a result of research, it was found that not only the electronic resistance inside the PTC resistor layer is high, but also electronic resistance at the interface between the PTC resistor layer and the current collector and electronic resistance at the interface between the PTC resistor layer and the electrode active material layer, are high. This seems to be because adhesion between the PTC resistor layer and the current collector at the interface therebetween and adhesion between the PTC resistor layer and the electrode active material layer at the interface therebetween, are decreased due to the presence of the electroconductive material and the insulating inorganic substance on the surface of the PTC resistor layer.

The production method of the disclosed embodiments comprises at least a total of two pressings, that is, pressing that is carried out for the purpose of applying a relatively high pressure mainly to the electrode active material layer (pressing B) and pressing that is carried out for the purpose of applying a relatively low pressure mainly to the PTC resistor layer (pressing A1 or A2), whereby the electrode for solid-state batteries in which electronic resistance at normal temperature is low, can be obtained. Since a high pressing pressure can be applied to the electrode active material layer in the pressing B, electronic resistance inside the electrode active material layer can be reduced, and both suppression of breaking of the current collector and reduction of the electronic resistance at the interface between the current collector and the PTC resistor layer, can be achieved in the pressing A1. In addition, in the pressing A2, the electronic resistance in the electrode active material layer can be reduced, and both suppression of breaking of the current collector and reduction of the electronic resistance at the interface between the electrode active material layer and the PTC resistor layer, can be achieved.

Hereinafter, the method for producing the electrode for solid-state batteries according to the disclosed embodiments, will be described in detail.

### 1. Electrode for Solid-State Batteries

The electrode obtained by the production method of the disclosed embodiments is an electrode for use in a solid-state battery comprising a cathode, an anode and an electrolyte layer disposed between the cathode and the anode. The electrode is at least one of the cathode and the anode, and the electrode comprises a current collector, an electrode active material layer and a PTC resistor layer disposed between the current collector and the electrode active material layer.

An example of the basic structure of the solid-state battery will be described with reference to FIG. 6.

As shown in FIG. 6, a solid-state battery 100, in which the electrode obtained by the production method of the disclosed embodiments is used, comprises a cathode 5, an anode 6, and an electrolyte layer 7 disposed between the cathode 5 and the anode 6.

FIG. 6 is a schematic view of an example of the basic structure of the solid-state battery. The solid-state battery 100 may be a battery in a common form such as a coin form, a flat plate form and a cylindrical form.

In FIG. 6, the solid-state battery is schematically shown as a single cell. The solid-state battery may be an assembly of the single cells. As the cell assembly, examples include, but are not limited to, a cell stack composed of a stack of flat plate cells.

The solid-state battery comprises the electrolyte layer 7 disposed between the cathode 5 and the anode 6. In the disclosed embodiments, the solid-state battery means a battery in which a solid electrolyte is used, and all the components of the solid-state battery are not needed to be solid. Accordingly, the electrolyte layer 7 is not particularly limited, as long as it can conduct transferred ions. As the electrolyte layer 7, examples include, but are not limited to, a polymer solid electrolyte-containing layer, an oxide solid electrolyte-containing layer, a sulfide solid electrolyte-containing layer, and a porous separator impregnated with an aqueous or non-aqueous electrolyte solution.

The electrode for solid-state batteries obtained by the production method of the disclosed embodiments, is at least one of the cathode and the anode, and the electrode comprises a current collector, an electrode active material layer and a PTC resistor layer disposed between the current collector and the electrode active material layer.

An example of the structure of the electrode for solid-state batteries obtained by the production method of the disclosed embodiments, will be described with reference to FIG. 1.

As shown in FIG. 1, an electrode 10 for solid-state batteries obtained by the production method of the disclosed embodiments, comprises a current collector 2, an electrode active material layer 3, and a PTC resistor layer 1 disposed between the current collector 2 and the electrode active material layer 3. At least one of the cathode 5 and the anode 6 shown in FIG. 6 corresponds to the electrode 10 for solid-state batteries shown in FIG. 1.

The material for the current collector 2 is not particularly limited, as long as it has electron conductivity. As the material for the current collector, examples include, but are not limited to, Al, Cu, Ni, Fe and SUS. When the electrode for solid-state batteries obtained by the production method of the disclosed embodiments, is the cathode, the material for the current collector may be Al. When the electrode for solid-state batteries is the anode, the material for the current collector may be Cu.

The electrode active material layer 3 is not particularly limited, as long as it contains at least an electrode active material. As needed, it may contain a binder, an electroconductive material, and a solid electrolyte.

When the electrode for solid-state batteries obtained by the production method of the disclosed embodiments, is the cathode, the electrode active material is not particularly limited, as long as it is an electrode active material that is generally used as a cathode active material. For example, when the transferred ions are lithium ions, as the cathode active material, examples include, but are not limited to, a compound having a layered structure (such as LiCoO₂ and LiNiO₂), a compound having a spinel-type structure (such as LiMn₂O₄), and a compound having an olivine-type structure (such as LiFePo₄).

When the electrode for solid-state batteries obtained by the production method of the disclosed embodiments, is the anode, the electrode active material is not particularly limited, as long as it is an electrode active material that is generally used as an anode active material. For example, when the transferred ions are lithium ions, as the anode active material, examples include, but are not limited to, a carbonaceous material, a lithium alloy, an oxide and a nitride.

The binder is not particularly limited, as long as it is chemically and electrically stable. As the binder, examples include, but are not limited to, a fluorine-based binder such as polyvinylidene fluoride (PVDF) and polytetrafluoroethylene (PTFE).

The electroconductive material is not particularly limited, as long as it has electroconductivity. As the electroconductive material, examples include, but are not limited to, carbonaceous materials such as carbon black, activated carbon, carbon fiber (e.g., carbon nanotube, carbon nanofiber) and graphite.

The material for the solid electrolyte is not particularly limited, as long as it has ion conductivity. As the material, examples include, but are not limited to, inorganic materials such as a sulfide material and an oxide material. As the sulfide material, examples include, but are not limited to, Li₂S—SiS₂, LiI—Li₂S—Si₂, LiI—Li₂S—P₂S₅, Li₂S—P₂S₅—LiI—LiBr, LiI—Li₂OLi₂S—P₂S₅, LiI—Li₂S—P₂O₅, LiI—Li₃PO₄—P₂S₅, Li₂S—P₂S₅, Li₃PS₄ and Li₁₀GeP₂S₁₂.

The PTC resistor layer 1 is laminated so as to be disposed between the current collector 2 and the electrode active material layer 3.

The PTC resistor layer 1 may contain the insulating inorganic substance in addition to the electroconductive material and the polymer, since the PTC resistor layer 1 can maintain its structure and exert the PTC resistor function even when overheating is caused or pressure is applied in the misuse.

The thickness of the PTC resistor layer 1 obtained by the production method of the disclosed embodiments, is not particularly limited. It may be from about 1 μm to about 30 μm.

Generally, in some cases, a solid-state battery includes a confining member for the purpose of increasing adhesion between the battery components at the interface therebetween. For the electrode obtained by the production method of the disclosed embodiments, both the adhesion between the PTC resistor layer and the current collector at the interface therebetween and the adhesion between the PTC resistor layer and the electrode active material layer at the interface therebetween, are high, and a smaller confining member than ever before can be used. Accordingly, the energy density of a solid-state battery can be increased. When the PTC resistor layer 1 contains the insulating inorganic substance in addition to the electroconductive material and the polymer, the electrode is highly effective in the pressure-applied condition as described above. Accordingly, it is especially suitable for a solid-state battery to which pressure is applied in the laminating direction by a confining member, etc.

An example of the basic structure of a solid-state battery comprising a solid-state battery member and a confining member, will be described with reference to FIG. 7.

As shown in FIG. 7, the above-described solid-state battery is used as a battery member 100′, and a confining member 200 is combined with the battery member 100′ so that pressure can be applied in the laminating direction of the battery member 100′.

Hereinafter, the production process of the first embodiment and that of the second embodiment will be described in order.

### 2. First Embodiment

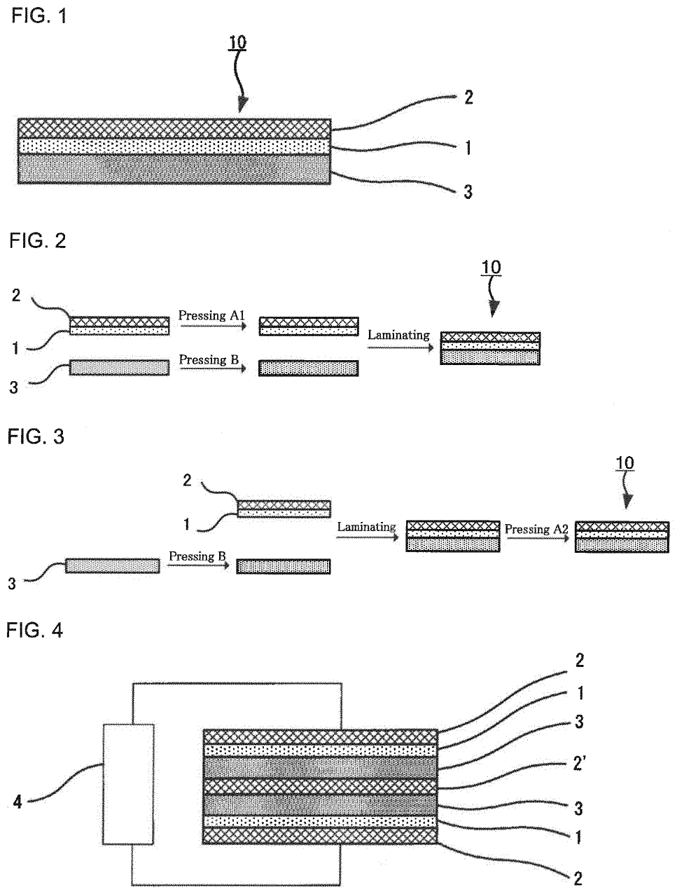

As shown in FIG. 2, the production method of the first embodiment comprises at least the following two pressings: pressing the current collector on which the PTC resistor layer is formed (pressing A1) and pressing an electrode active material member comprising at least the electrode active material layer (pressing B).

### 2-1. Forming the PTC Resistor Layer

In the first embodiment, this is a step of forming the PTC resistor layer by applying a slurry containing an electroconductive material and a polymer to at least one of both surfaces of the current collector and drying the applied slurry.

### (1) Slurry

The slurry contains an electroconductive material and a polymer.

The method for forming the PTC resistor layer by applying the slurry on the current collector and drying the applied slurry, is not particularly limited. In general, the electroconductive material and the polymer are dispersed in a non-aqueous solvent; the resulting dispersion is casted on the current collector; and the casted dispersion is dried. To uniformly coat the current collector surface with the PTC resistor layer, the solid content concentration of the dispersion containing the electroconductive material and the polymer may be about 12 mass %. When the dispersion contains the insulating inorganic substance, to uniformly coat the current collector surface with the PTC resistor layer, the solid content concentration of the dispersion containing the electroconductive material, the insulating inorganic substance and the polymer may be about 24 mass %.

The thickness of the PTC resistor layer is not particularly limited. The thickness may be from about 1 to about 10 μm.

### (2) Electroconductive Material

The electroconductive material contained in the slurry is not particularly limited, as long as it has electroconductivity. As the electroconductive material, examples include, but are not limited to, carbonaceous materials such as carbon black, activated carbon, carbon fiber (e.g., carbon nanotube, carbon nanofiber) and graphite. The electroconductive material may be carbon black. In general, the electroconductive material is in a particulate form. The electroconductive material may be primary particles or secondary particles.

The particle size distribution of the electroconductive material particles is not particularly limited. The particle size distribution of the particles may be a normal distribution when it is represented by a frequency distribution.

The content ratio of the electroconductive material in the slurry is not particularly limited. When the total volume of the electroconductive material and the polymer in the slurry is determined as 100 volume %, the content ratio of the electroconductive material may be 10 volume % or more, or it may 50 volume % or more, for example. Also when the total volume of the electroconductive material and the polymer in the slurry is determined as 100 volume %, the content ratio of the electroconductive material may be 30 volume % or less, or it may be 20 volume % or less, for example.

In the case of the slurry containing the insulating inorganic substance in addition to the electroconductive material and the polymer, when the total volume of the electroconductive material, the insulating inorganic substance and the polymer in the slurry is determined as 100 volume %, the content ratio of the electroconductive material may be 7 volume or more, or it may be 10 volume % or more. Also when the total volume of the electroconductive material, the insulating inorganic substance and the polymer in the slurry is determined as 100 volume %, the content ratio of the electroconductive material may be 95 volume % or less, or it may be 60 volume % or less, for example.

### (3) Polymer

The polymer contained in the slurry is not particularly limited, as long as it is a polymer that expands when its temperature exceeds its melting point by heating. As the polymer, examples include, but are not limited to, thermoplastic resins such as polypropylene, polyethylene, polyvinyl chloride, polyvinylidene fluoride (PVDF), polystyrene, ABS resin, methacryl resin, polyamide, polyester, polycarbonate and polyacetal. These polymers may be used alone or in combination of two or more kinds.

From the viewpoint of melting point and ease of processing, the polymer may be polyvinylidene fluoride or polyethylene. The polymer may be polyvinylidene fluoride.

The content ratio of the polymer in the slurry is not particularly limited. When the total volume of the electroconductive material and the polymer in the slurry is determined as 100 volume %, the content ratio of the polymer in the slurry may be 5 volume % or more, or it may be 10 volume % or more. When the total volume of the electroconductive material and the polymer in the slurry is determined as 100 volume %, the content ratio of the polymer in the slurry may be 90 volume % or less, or it may be 80 volume % or less.

In the case of the slurry containing the insulating inorganic substance in addition to the electroconductive material and the polymer, when the total volume of the electroconductive material, the insulating inorganic substance and the polymer in the slurry is determined as 100 volume %, the content ratio of the polymer in the slurry may be 8 volume or more, or it may be 30 volume % or more. Also when the total volume of the electroconductive material, the insulating inorganic substance and the polymer in the slurry is determined as 100 volume %, the content ratio of the polymer in the slurry may be 50 volume % or less, or it may be 50 volume % or less.

### (4) Insulating Inorganic Substance

The insulating inorganic substance contained in the slurry functions to suppress deformation and fluidization of the PTC resistor layer in the thus-obtained electrode, both of which are due to heating and pressure, in the misuse. In general, the insulating inorganic substance is in a particulate form. The insulating inorganic substance may be primary particles or secondary particles.

The average particle diameter (D₅₀) of the insulating inorganic substance may be from 0.2 μm to 5 μm, or it may be from 0.4 μm to 2 μm. The average particle diameter (D₅₀) means a particle diameter at which, when the diameters of the particles are measured and arranged in ascending order, the accumulated volume of the particles is half (50%) the total volume of the particles. The average particle diameter (D₅₀) can be measured by use of a laser diffraction/scattering particle size distribution analyzer, for example. The distribution of the insulating inorganic substance particles is not particularly limited. The distribution of the particles may be a normal distribution when it is represented by a frequency distribution.

The insulating inorganic substance is not particularly limited, as long as it is a material that has a higher melting point than the below-described polymer. As the insulating inorganic substance, examples include, but are not limited to, a metal oxide and a metal nitride. As the metal oxide, examples include, but are not limited to, alumina, zirconia and silica. As the metal nitride, examples include, but are not limited to, a silicon nitride. Also, as the insulating inorganic substance, examples include, but are not limited to, a ceramic material. The insulating inorganic substance may be a metal oxide.

The content ratio of the insulating inorganic substance in the slurry is not particularly limited. When the total volume of the electroconductive material, the insulating inorganic substance and the polymer in the slurry is determined as 100 volume %, the content ratio of the insulating inorganic substance in the slurry may be 30 volume % or more and 60 volume % or more.

When the content ratio of the insulating inorganic substance is too small, it may be difficult to sufficiently suppress the deformation and fluidization of the thus-obtained PTC resistor layer, both of which are due to heating and pressure. On the other hand, when the content ratio of the insulating inorganic substance is too large, the content ratio of the polymer is relatively small. As a result, increasing the distance between the electroconductive material particles by the volume-expanded polymer is not possible, and an increase in electronic resistance may be insufficient. Also, electroconductive paths, which are formed by the electroconductive material, may be blocked by the insulating inorganic substance, and the electron conductivity of the PTC resistor layer during normal use may decrease.

When the total volume of the insulating inorganic substance and the polymer in the slurry is determined as 100 volume %, the content ratio of the insulating inorganic substance may be 42 volume % or more, or it may be 66 volume % or more, for example. Also when the total volume of the insulating inorganic substance and the polymer in the slurry is determined as 100 volume %, the content ratio of the insulating inorganic substance may be 89 volume % or less, or it may be 66 volume % or less, for example.

### (5) Non-Aqueous Solvent

The slurry may contain a non-aqueous solvent for dissolving/dispersing the above-mentioned components. The type of the non-aqueous solvent is not particularly limited. As the non-aqueous solvent, examples include, but are not limited to, N-methylpyrrolidone, acetone, methyl ethyl ketone and dimethylacetamide. From the viewpoint of safety such as high flash point, small influence on human body and so on, the non-aqueous solvent may be N-methylpyrrolidone.

The content ratio of the non-aqueous solvent in the slurry is not particularly limited. When the total volume of the electroconductive material and the polymer in the slurry is determined as 100 volume %, the content ratio of the non-aqueous solvent in the slurry may be 90 volume % or more, or it may be 95 volume % or more. Also, the content ratio of the non-aqueous solvent in the slurry may be 97 volume % or less, or it may be 95 volume % or less.

In the case of the slurry containing the insulating inorganic substance in addition to the electroconductive material and the polymer, when the total volume of the electroconductive material, the insulating inorganic substance and the polymer in the slurry is determined as 100 volume %, the content ratio of the non-aqueous solvent in the slurry may be 81 volume % or more, or it may be 82 volume % or more. Also when the total volume of the electroconductive material, the insulating inorganic substance and the polymer in the slurry is determined as 100 volume %, the content ratio of the non-aqueous solvent in the slurry may be 93 volume % or less, or it may be 91 volume % or less.

### 2-2. Pressing A1

This is a step of pressing the current collector on which the PTC resistor layer is formed, at a maximum pressure a1.

In the disclosed embodiments, the term “maximum pressure” in the pressings means the maximum pressure value applied to the pressing target in the pressings. As will be described below, the pressing method used in the disclosed embodiments may be flat pressing, roll pressing, etc. Also, a pressing method in which pressure applied to the pressing target changes with time, may be used. Accordingly, in the disclosed embodiments, regardless of the type of the pressing method, the method for producing the electrode for solid-state batteries is unambiguously defined by the maximum pressure in the pressings. Hereinafter, unless otherwise noted, the maximum pressure in the pressings may be expressed as “pressing pressure”.

As described above, the PTC resistor layer containing the electroconductive material, etc., has a problem with the adhesion between the PTC resistor layer and the current collector at the interface therebetween and the adhesion between the PTC resistor layer and the electrode active material layer at the interface therebetween.

In the method for producing the electrode for solid-state batteries according to the first embodiment, by pressing the current collector on which the PTC resistor layer is formed, the adhesion between the PTC resistor layer and the current collector at the interface therebetween, is increased, and the surface of the PTC resistor layer is flattened and smoothed. Since the surface of the electrode active material layer of the electrode active material member obtained in the below-described pressing B, is also flattened and smoothed, the adhesion between the PTC resistor layer and the electrode active material layer at the interface therebetween, can be also increased.

The maximum pressure a1 applied in the pressing A1 is smaller than the maximum pressure b applied in the pressing B to the below-described electrode active material member comprising at least the electrode active material layer and excluding the PTC resistor layer. That is, the maximum pressures a1 and b satisfy the following relation: b a1. Since a high pressing pressure can be applied to the electrode active material layer in the pressing B, the electronic resistance inside the electrode active material layer can be reduced, and both suppression of breaking of the current collector by the pressing A1 and reduction of the electronic resistance at the interface between the current collector and the PTC resistor layer, can be achieved.

If a1≥b, there is a disadvantage in that the current collector is damaged or the electronic resistance of the electrode active material layer thus obtained is high. Accordingly, in the case of a1≥b, all of suppression of breaking of the current collector, reduction of the electronic resistance inside the electrode active material layer, and reduction of the electronic resistance at the interface between the current collector and the PTC resistor layer, cannot be achieved.

The pressing method used in the pressing A1 is not particularly limited. As the pressing method, examples include, but are not limited to, flat pressing and roll pressing. The pressing method may be roll pressing.

In the production method of the first embodiment, the maximum pressure a1 applied in the pressing A1 may be from 199 MPa to 795 MPa. When the maximum pressure a1 is less than 199 MPa, the surface of the PTC resistor layer may be insufficiently flattened and smoothed. When the maximum pressure a1 is more than 795 MPa, the PTC resistor function may deteriorate.

### 2-3. Pressing B

This is a step of pressing the electrode active material member comprising at least the electrode active material layer and excluding the PTC resistor layer, at a maximum pressure b.

The electrode active material member may be the electrode active material layer itself or a laminate of the electrode active material layer and one or more other layers (excluding the PTC resistor layer).

As described above, by applying a higher pressure than the pressing A1 to the electrode active material member comprising the electrode active material layer and excluding the PTC resistor layer, the density of the electrode active material layer can be increased, and the surface of the electrode active material layer can be flattened and smoothed, without a deterioration in the PTC resistor function.

The pressing method used in the pressing B is not particularly limited. As the pressing method, examples include, but are not limited to, flat pressing and roll pressing. The pressing method may be roll pressing.

In the production method of the first embodiment, the maximum pressure b applied in the pressing B may be from 400 MPa to 3,000 MPa.

### 2-4. Obtaining the Electrode for Solid-State Batteries

This is a step of obtaining the electrode for solid-state batteries by laminating the current collector on which the PTC resistor layer is formed and the electrode active material member so that the PTC resistor layer and the electrode active material layer are in contact with each other.

The electrode active material layer whose surface was flattened and smoothed in the pressing 3, is laminated on the PTC resistor layer whose surface was flattened and smoothed in the pressing A1. Accordingly, in the thus-obtained electrode for solid-state batteries, the adhesion between the electrode active material layer and the PTC resistor layer at the interface therebetween, is increased and makes it possible to reduce electronic resistance at normal temperature.

### 3. Second Embodiment

As shown in FIG. the production method of the second embodiment comprises at least the following two pressings: pressing an electrode active material member comprising at least the electrode active material layer 3 at a maximum pressure b pressing B) and pressing the electrode precursor comprising at least the current collector 2, the electrode active material layer 3 and the PTC resistor layer 1 at a maximum pressure a2 (pressing A2).

Points in common between the first and second embodiments are as follows: the production method comprises at least two pressings; the production method comprises pressing the electrode active material member comprising at least the electrode active material layer (pressing B); and the maximum pressure b1 applied to the electrode active material layer is larger than the maximum pressures (a1 and a2) applied to the PTC resistor layer.

Meanwhile, the first and second embodiments differ in the following point: when pressure is applied to the PTC resistor layer, the pressing target in the first embodiment is the current collector on which the PTC resistor layer is formed, and the pressing target in the second embodiment is the electrode precursor comprising at least the current collector, the PTC resistor layer and the electrode active material layer.

In the first embodiment, the adhesion between the PTC resistor layer and the electrode active material layer at the interface therebetween, can be increased by flattening and smoothing the PTC resistor layer surface and the electrode active material layer surface. In the second embodiment, it can be increased by applying the maximum pressure a2 to the interface between the PTC resistor layer and the electrode active material layer by pressing.

### 3-1. Forming the PTC Resistor Layer

In the second embodiment, as with the first embodiment, this is a step of forming the PTC resistor layer by applying a slurry containing an electroconductive material and a polymer to a surface of the current collector and drying the applied slurry. This step will not be described here, since it is the same as described above in “2. First embodiment”.

### 3-2. Pressing B

This is a step of pressing the electrode active material member comprising at least the electrode active material layer and excluding the PTO resistor layer. This step will not be described here, since it is the same as described above in “2. First embodiment”.

### 3-3. Obtaining the Electrode Precursor

This is a step of obtaining the electrode precursor by laminating the current collector on which the PTC resistor layer is formed and the electrode active material member so that the PTC resistor layer and the electrode active material layer are in contact with each other.

In the first embodiment, the current collector on which the PTC resistor layer is formed, is pressed by the pressing A1. Accordingly, at the stage of obtaining the electrode for solid-state batteries, the adhesion between the PTC resistor layer and the current collector at the interface therebetween, is already increased, and the PTC resistor layer surface is already flattened and smoothed.

In the second embodiment, at the stage of laminating the current collector on which the PTC resistor layer is formed and the electrode active material member so that the PTC resistor layer and the electrode active material layer are in contact with each other, both the adhesion between the PTC resistor layer and the current collector at the interface therebetween and the adhesion between the PTC resistor layer and the electrode active material layer at the interface therebetween, are insufficient.

### 3-4. Pressing A2

This is a step of pressing the electrode precursor at a maximum pressure a2.

In the second embodiment, by applying a smaller pressure than the pressing B while the interface between the PTC resistor layer and the current collector and the interface between the PTC resistor layer and the electrode active material layer are formed, the adhesion between the PTC resistor layer and the current collector at the interface therebetween and the adhesion between the PTC resistor layer and the electrode active material layer at the interface therebetween, can be increased without a deterioration in the PTC resistor function. Also for the pressing A2, as with the above-described pressing A1, the electronic resistance in the electrode active material layer can be reduced, and both suppression of breaking of the current collector and reduction of the electronic resistance at the interface between the electrode active material layer and the PTC resistor layer, can be achieved.

The pressing method used in the pressing A2 is not particularly limited. As the pressing method, examples include, but are not limited to, flat pressing and roll pressing.

In the production method of the second embodiment, the maximum pressure a2 applied in the pressing A2 may be from 20 MPa to 710 MPa. When the maximum pressure a2 is less than 20 MPa, both the adhesion between the PTC resistor layer and the current collector at the interface therebetween and the adhesion between the PTC resistor layer and the electrode active material layer at the interface therebetween, may be insufficient. When the maximum pressure a2 is more than 710 MPa, the PTC resistor function may deteriorate.

### 4. Production Method of a Solid-State Battery

A solid-state battery can be produced by use of the electrode for solid-state batteries obtained in the first or second embodiment. The method for producing the solid-state battery by use of the electrode for solid-state batteries obtained by the production method of the disclosed embodiments, is not particularly limited. For example, the solid-state battery can be obtained by laminating the electrode for solid-state batteries which is composed of the current collector, the PTC resistor layer and the electrode active material layer, the electrolyte layer and a counter electrode in this order. In this case, when the electrode for solid-state batteries is an anode, the counter electrode is a cathode. When the electrode for solid-state batteries is a cathode, the counter electrode is an anode. Also, both the anode and the cathode may be the electrodes obtained by the production method of the disclosed embodiments.

The production method of the disclosed embodiments may comprise applying a confining pressure c to the battery member comprising the electrode for solid-state batteries obtained in the first or second embodiment, after the battery member is combined with the confining member (confining C).

The confining pressure c applied in the confining C may satisfy the following relation: b>(a1 or a2)>c. As described above, in the electrode obtained by the production method of the disclosed embodiments, the electronic resistance at normal temperature is low. Accordingly, the pressure applied in the confining C can be low.

### EXAMPLES

Hereinafter, the disclosed embodiments will be further clarified by the following examples. The disclosed embodiments are not limited to the following examples, however.

### 1. Evaluation of Electrodes for Solid-State Batteries

### <Production of Samples for Electrode Electronic Resistance Evaluation>

### Example 1

### (1-1) Forming a PTC Resistor Layer

The following materials for a slurry were prepared.
Electroconductive material: Furnace black (manufactured by: Tokai Carbon Co., Ltd., average primary particle diameter: 66 nm)
Insulating inorganic substance: Alumina (particle diameter D₉₀: 6 μm)
Polymer: PVDF (product name: KF POLYMER L #9130, manufactured by: Kureha Corporation)
Solvent: N-methylpyrrolidone

The furnace black, the PVDF and the alumina were mixed at a volume ratio of 10:30:60 with the N-methylpyrrolidone, thereby producing the slurry. Then, the slurry was applied on an aluminum foil having a thickness of 15 μm. The applied slurry was dried in a stationary drying oven at 100° C. for one hour, thereby forming a PTC resistor layer.

### (1-2) Pressing A1

The current collector on which the PTC resistor layer was formed, was subjected to roll pressing in the conditions of a pressing pressure a1 of 5.6 kN/cm (equivalent to 199 MPa) and room temperature, thereby obtaining a PTC resistor layer-current collector laminate.

The above steps were carried out twice to produce a total of two PTC resistor layer-current collector laminates.

### (1-3) Pressing B and so on

The following materials were put in a polypropylene (PP) container to obtain a mixture.
Cathode active material: LiNi_{3/3}Co_{1/3}Mn_{1/3}O₂ particles (average particle diameter: 6 μm)
Solid electrolyte: Li₂S—P₂S₅-based glass ceramic particles containing LiI and LiBr (average particle diameter: 0.8 μm)
Binder: A 5 mass % solution of a PVDF-based binder in butyl butyrate
Electroconductive material: VGCF
Solvent: Heptane

The mixture in the container was subjected to ultrasonication by use of an ultrasonic homogenizer (product name: UH-50, manufactured by: SMT Co., Ltd.) for 30 seconds. Next, the container was shaken by a shaking device (product name: 6778, manufactured by: Corning) for three minutes. Then, the mixture in the container was further subjected to ultrasonication by use of the ultrasonic homogenizer for 30 seconds, thereby preparing a paste for forming the cathode active material layer.

The paste for forming the cathode active material layer was applied on an aluminum foil by a doctor blade method. The applied slurry was dried, thereby forming the cathode active material layer on the aluminum foil.

The above step was carried out twice to produce a total of two cathode active material layers.

The two cathode active material layers were laminated so that one of the cathode active material layers was in contact with the aluminum foil of the other cathode active material layer. A laminate thus obtained was subjected to roll pressing under the conditions of a line pressure of 10 kN/cm (equivalent to 355 MPa) and room temperature.

After the roll pressing, the aluminum foil disposed outside the laminate was peeled off from the laminate so that the laminate obtained the following layer structure: cathode active material layer-aluminum foil-cathode active material layer. The cathode active material layer-aluminum foil-cathode active material layer laminate (an electrode active material member) was subjected to roll pressing under the conditions of a pressing pressure b of 50 kN/cm (equivalent to 1775 MPa) and 165° C.

### (1-4) Obtaining a Sample for Electrode Electronic Resistance Evaluation

The PTC resistor layer-current collector laminates were attached to both sides of the cathode active material layer-aluminum foil-cathode active material layer laminate so that the cathode active material layers were in contact with the PTC resistor layers, thereby obtaining a sample for electrode electronic resistance evaluation as shown in FIG. 4.

### Example 2

The sample for electrode electronic resistance evaluation of Example 2 was obtained in the same manner as Example 1, except that in “(1-2) Pressing A1”, the pressing pressure a1 was changed to 14.2 kN/cm (equivalent to 504 MPa).

### Example 3

The sample for electrode electronic resistance evaluation of Example 3 was obtained in the same manner as Example 1, except that in “(1-2) Pressing A1”, the pressing pressure a1 was changed to 22.4 kN/cm (equivalent to 795 MPa).

### Example 4

The sample for electrode electronic resistance evaluation of Example 4 was obtained in the same manner as Example 1, except that in “(1-1) Forming a PTC resistor layer”, the mixing ratio of the furnace black, the PVDF and the alumina in the slurry was changed to a volume ratio of 20:80:0, and in “(1-2) Pressing A1”, the pressing pressure a1 was changed to 7.1 kN/cm (equivalent to 252 MPa).

### Example 5

### (2-1) Forming a PTC Resistor Layer

The following materials for a slurry were prepared.
Electroconductive material Furnace black (manufactured by: Tokai. Carbon Co., Ltd., average primary particle diameter: 66 nm)
Insulating inorganic substance: Alumina (particle diameter D₉₀: 6 μm)
Polymer: PVDF (product name: KF POLYMER L #9130, manufactured by: Kureha Corporation)
Solvent: N-methylpyrrolidone

The furnace black, the PVDF and the alumina were mixed at a volume ratio of 10:30:60 with the N-methylpyrrolidone, thereby producing the slurry. Then, the slurry was applied on an aluminum foil having a thickness of 15 μm. The applied slurry was dried in the stationary drying oven at 100° C. for one hour, thereby forming a PTC resistor layer.

The above step was carried out twice to produce a total of two PTC resistor layer-current collector laminates.

### (2-2) Pressing B and so on

The following materials were put in a polypropylene (PP) container to obtain a mixture.
Cathode active material: LiNi_{1/3}Co_{1/3}Mn_{1/3}O₂ particles (average particle diameter: 6 μm)
Solid electrolyte: Li₂S—P₂S₅-based glass ceramic particles containing LiI and LiBr (average particle diameter: 0.8 μm)
Binder: A 5 mass % solution of a PVDF-based binder in butyl butyrate
Electroconductive material: VGCF
Solvent: Heptane

The mixture in the container was subjected to ultrasonication by use of an ultrasonic homogenizer (product name; UH-50, manufactured by: SMT Co., Ltd.) for 30 seconds. Next, the container was shaken by a shaking device (product name: 6778, manufactured by: Corning) for three minutes. Then, the mixture in the container was further subjected to ultrasonication by use of the ultrasonic homogenizer for 30 seconds, thereby preparing a paste for forming the cathode active material layer.

The paste for forming the cathode active material layer was applied on an aluminum foil by a doctor blade method. The applied slurry was dried, thereby forming the cathode active material layer on the aluminum foil.

The above step was carried out twice to produce a total of two cathode active material layers.

The two cathode active material layers were laminated so that one of the cathode active material layers was in contact with the aluminum foil of the other cathode active material layer. A laminate thus obtained was subjected to roll pressing under the conditions of a line pressure of 10 kN/cm (equivalent to 355 MPa) and room temperature.

After the roll pressing, the aluminum foil disposed outside the laminate was peeled off from the laminate so that the laminate obtained the following layer structure: cathode active material layer-aluminum foil cathode active mat layer. The cathode active material layer-aluminum foil-cathode active material layer laminate (an electrode active material member) was subjected to roll pressing under the conditions of a pressing pressure b of 50 kN/cm (equivalent to 1775 MPa) 165° C.

### (2-3) Obtaining an Electrode Precursor

The PTC resistor layer-current collector laminates were attached to both sides of the cathode active material layer-aluminum foil-cathode active material layer laminate so that the cathode active material layers were in contact with the PTC resistor layers, thereby producing an electrode precursor.

### (2-4) Pressing A2

The electrode precursor was subjected to flat pressing in the conditions of a pressing pressure a2 of 50 MPa (equivalent to 1.4 kN/cm) and room temperature, thereby obtaining the sample for electrode electronic resistance evaluation of Example 5, which is shown in FIG. 4.

### Example 6

The sample for electrode electronic resistance evaluation of Example 6 was obtained in the same manner as Example 5, except that in “(2-4) Pressing A2”, the electrode precursor was subjected to roll pressing in the conditions of a pressing pressure a2 of 20 kN/cm (equivalent to 710 MPa) and room temperature, in place of the flat pressing.

### Example 7

The sample for electrode electronic resistance evaluation of Example 7 was obtained in the same manner as Example 5, except that in “(2-1) Forming a PTC resistor layer”, the mixing ratio of the furnace black, the PVDF and the alumina in the slurry was changed to a volume ratio of 20:80:0, and in “(2-4) Pressing A2”, the electrode precursor was subjected to roll pressing in the conditions of a pressing pressure a2 of 0.56 kN/cm (equivalent to 20 MPa) and room temperature, in place of the flat pressing.

### Example 8

The sample for electrode electronic resistance evaluation of Example 8 was obtained in the same manner as Example 7, except that in “(2-4) Pressing A2”, the pressing pressure a2 of the roll pressing was changed to 1.13 kN/cm (equivalent to 40 MPa).

### Example 9

The sample for electrode electronic resistance evaluation of Example 9 was obtained in the same manner as Example 7, except that in “(2-4) Pressing A2”, the pressing pressure a2 of the roll pressing was changed to 2.26 kN/cm (equivalent to 80 MPa).

### Comparative Example 1

The sample for electrode electronic resistance evaluation of Comparative Example 1 was obtained in the same manner as Example 1, except that “(1-2) Pressing A1” was not carried out.

### Comparative Example 2

The sample for electrode electronic resistance evaluation of Comparative Example 2 was obtained in the same manner as Comparative Example 1, except that in “(1-1) Forming a PTC resistor layer”, the mixing ratio of the furnace black, the PVDF and the alumina in the slurry was changed to a volume ratio of 20:80:0.

### Comparative Example 3

The sample for electrode electronic resistance evaluation of Comparative Example 3 was obtained in the same manner as Example 5, except that in “(2-2) Pressing B and so on”, the cathode active material layer-aluminum foil-cathode active material layer laminate (the electrode active material member) was not subjected to roll pressing, and in “(2-4) Pressing A2”, the pressing pressure a2 of the flat pressing was changed to 40 MPa (equivalent to 1.1 kN/cm).

### <Evaluation of Room-Temperature Resistance>

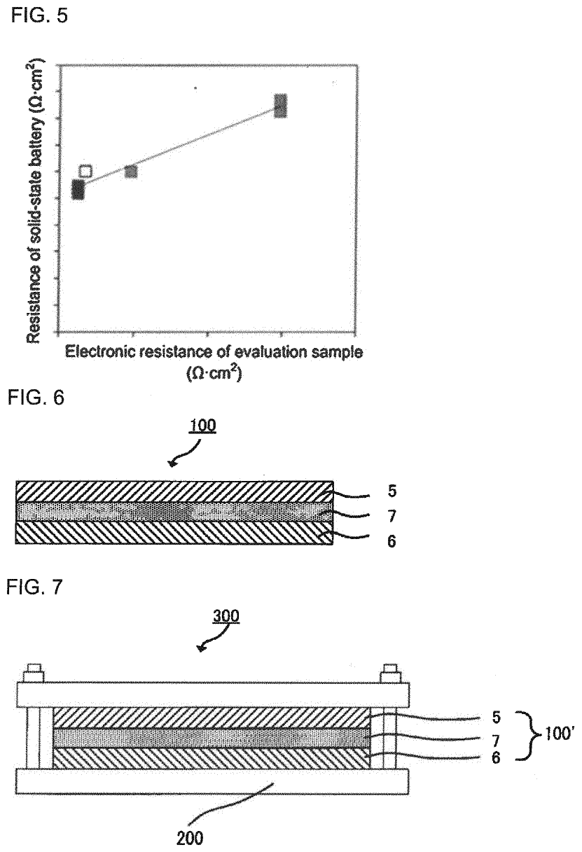

The sample for electrode electronic resistance evaluation obtained in Example 1 was combined with a confining member, and a confining pressure of 0.3 kN/cm (equivalent to 10.7 MPa) was applied to the sample by the confining member. While the sample was in this state, a constant current of 1 mA was passed between the current collectors at room temperature (25° C.). Voltage between terminals was measured, and an electronic resistance value was calculated. The electronic resistance values of Examples 2 to 9 and Comparative Examples 1 and 2, were obtained in the same manner. The sample for electrode electronic resistance evaluation obtained in Comparative Example 3 was combined with a confining member, and a confining pressure of 10 MPa was applied to the sample by the confining member. The electronic resistance value of Comparative Example 3 was obtained in the same manner as above. A correlation as shown in FIG. 5 is found between the electronic resistances of the evaluation samples obtained in this test and the resistances of solid-state batteries obtained by use of the electrodes used in this test (that is, the evaluation samples obtained in this test).

### 2. Evaluation Results

Items shown in Tables 1 and 2 include “Pressing pressure a1 (MPa)”, “Pressing pressure b (MPa)”, “Confining pressure (MPa)” and “Relative electronic resistance (%)”.

Items shown in Tables 3 and 4 include “Pressing pressure b (MPa)”, “Pressing pressure a2 (MPa)”, “Confining pressure c (MPa)” and “Relative electronic resistance (%)”.

Tables 1 and 3 show the experimental results of the samples in which the composition of the PTC resistor layer, that is, the furnace black (C), the PVDF and the alumina (Al₂O₃) in the PTC resistor layer were at a volume ratio of 10:30:60. In Tables 1 and 3, each number shown under “Relative electronic resistance (%)” means a relative electronic resistance when the electronic resistance of Comparative Example 1 is determined as 100%.

Tables 2 and 4 show the experimental results of the samples in which the composition of the PTC resistor layer, that is, the furnace black (C), the PVDF and the alumina (Al₂O₃) in the PTC resistor layer were at a volume ratio of 20:80:0 (i.e., the experimental results of the samples in which alumina was not used). In Tables 2 and 4, each number shown under “Relative electronic resistance (%)” means a relative electronic resistance when the electronic resistance of Comparative Example 2 is determined as 100%. Also in Tables 2 and 4, each number in parentheses shown under “Relative electronic resistance (%)” means a relative electronic resistance when the electronic resistance of Comparative Example 1 (see Tables 1 and 3) is determined as 100%.

TABLE 1

| | Composition of | | | | Relative |
|---|---|---|---|---|---|
| | the PCT resistor | Pressing | Pressing | Confining | electronic |
| | layer C/PVDF/Al₂O₃ | pressure a1 | pressure b | pressure c | resistance |
| | (Volume ratio) | (MPa) | (MPa) | (MPa) | (%) |
| Comparative | 10/30/60 | — | 1775 | 10.7 | 100 |
| Example 1 | | | | | |
| Example 1 | 10/30/60 | 199 | 1775 | 10.7 | 54 |
| Example 2 | 10/30/60 | 504 | 1775 | 10.7 | 29 |
| Example 3 | 10/30/60 | 795 | 1775 | 10 7 | 33 |

TABLE 2

| | Composition of | | | | Relative |
|---|---|---|---|---|---|
| | the PCT resistor | Pressing | Pressing | Confining | electronic |
| | layer C/PVDF/Al₂O₃ | pressure a1 | pressure b | pressure c | resistance |
| | (Volume ratio) | (MPa) | (MPa) | (MPa) | (%) |
| Comparative | 20/80/0 | — | 1775 | 10.7 | 100 (12.0) |
| Example 2 | | | | | |
| Example 4 | 20/80/0 | 252 | 1775 | 10.7 | 94 (11.3) |

TABLE 3

| | Composition of | | | | Relative |
|---|---|---|---|---|---|
| | the PCT resistor | Pressing | Pressing | Confining | electronic |
| | layer C/PVDF/Al₂O₃ | pressure b | pressure a2 | pressure c | resistance |
| | (Volume ratio) | (MPa) | (MPa) | (MPa) | (%) |
| Comparative | 10/30/60 | 1775 | — | 10.7 | 100 |
| Example 1 | | | | | |
| Comparative | 10/30/60 | — | 40 | 10 | 10200 |
| Example 3 | | | | | |
| Example 5 | 10/30/60 | 1775 | 50 | 10.7 | 29 |
| Example 6 | 10/30/60 | 1775 | 710 | 10.7 | 45 |

TABLE 4

| | Composition of | | | | Relative |
|---|---|---|---|---|---|
| | the PCT resistor | Pressing | Pressing | Confining | electronic |
| | layer C/PVDF/Al₂O₃ | pressure b | pressure a2 | pressure c | resistance |
| | (Volume ratio) | (MPa) | (MPa) | (MPa) | (%) |
| Comparative | 20/80/0 | 1775 | — | 10.7 | 100 (12.0) |
| Example 2 | | | | | |
| Example 7 | 20/80/0 | 1775 | 20 | 10.7 | 90 (10.8) |
| Example 8 | 20/80/0 | 1775 | 40 | 10.7 | 65 (7.8) |
| Example 9 | 20/80/0 | 1775 | 80 | 10.7 | 69 (8.3) |

First, the results shown in Table 1 will be discussed.

The sample for electrode electronic resistance evaluation of Comparative Example 1 was produced without applying a pressing pressure to the current collector on which the PTC resistor layer was formed. The samples for electrode electronic resistance evaluation of Examples 1 to 3 were produced by applying a pressing pressure a1 of from 199 MPa to 795 MPa to the current collector on which the PTC resistor layer was formed. As shown in Table 1, when the electronic resistance of Comparative Example 1 is determined as 100%, the relative electronic resistances of Examples 1 to 3 are from 29% to 54% and low.

It is estimated that there is no large difference in the electronic resistance inside the PTC resistor layer between Comparative Example 1 and Examples 1 to 3. Accordingly, the reason for the lower relative electronic resistances of Examples 1 to 3 than Comparative Example 1, is presumed as follows: by applying a pressing pressure a1 of from 199 MPa to 795 MPa to the current collector on which the PTC resistor layer was formed, the adhesion between the current collector and the PTC resistor layer at the interface therebetween, was increased, and the surface of the PTC resistor layer was flattened and smoothed, whereby the adhesion between the electrode active material layer and the PTC resistor layer at the interface therebetween, was increased, and the electronic resistances at both of the interfaces were decreased.

Next, the results shown in Table 2 will be discussed.

The sample for electrode electronic resistance evaluation of Comparative Example 2 was produced without applying a pressing pressure a1 to the current collector on which the PTC resistor layer was formed. The sample for electrode electronic resistance evaluation of Example 4 was produced by applying a pressing pressure a1 of 252 MPa to the current collector on which the PTC resistor layer was formed. As shown in Table 2, when the electronic resistance of Comparative Example 2 is determined as 100%, the relative electronic resistance of Example 4 is 94% and low. This result indicates that even when the insulating inorganic substance is not used, as with the results in Table 1, by applying a pressing pressure a1 of 252 MPa to the current collector on which the PTC resistor layer is formed, both the electronic resistance at the interface between the current collector and PTC resistor layer and the electronic resistance at the interface between the electrode active material layer and the PTC resistor layer, are decreased.

Next, the results shown in Table 3 will be discussed.

The sample for electrode electronic resistance evaluation of Comparative Example 1 was produced without applying a pressing pressure a2 to the electrode precursor. The samples for electrode electronic resistance evaluation of Examples 5 and 6 were produced by applying a pressing pressure a2 of from 50 MPa to 710 MPa to the electrode precursor. As shown in Table 3, when the electronic resistance of Comparative Example 1 is determined as 100%, the relative electronic resistances of Examples 5 and 6 are from 29% to 45% and low. The reason for the lower relative electronic resistances of Examples 5 and 6 than Comparative Example 1, is presumed as follows: by pressing the pressing pressure a2 to the electrode precursor, the adhesion between the current collector and the PTC resistor layer at the interface therebetween and the adhesion between the electrode active material layer and the PTC resistor layer at the interface therebetween, were increased, and the electronic resistances at both of the interfaces were decreased.

For the sample for electrode electronic resistance evaluation of Comparative Example 3, since the cathode active material layer-aluminum foil-cathode active material layer laminate was not subjected to roll pressing in the pressing B, the pressing pressure b can be deemed as 0. Accordingly, the pressing pressure a2 can be said to be larger than the pressing pressure b in Comparative Example 3. In this case, the relative electronic resistance is 10,200% and very high. From this result, it is presumed that it is difficult to reduce the electronic resistance as long as at least the pressing pressure b is smaller than the pressing pressure a2. Also, it is presumed that even if the pressing pressure b is larger than the pressing pressure a2, the electronic resistance of the sample for electrode electronic resistance evaluation can be measured without breaking the current collector. Due to the above reason, it is presumed that since the pressing pressure b is larger than the pressing pressure a2, both reduction of the electronic resistance and reduction of damage to the current collector are achieved.

Next, the results shown in Table 4 will be discussed.

The sample for electrode electronic resistance evaluation of Comparative Example 2 was produced without applying a pressing pressure a2 to the electrode precursor. The samples for electrode electronic resistance evaluation of Examples 7 to 9 were produced by applying a pressing pressure a2 of from 20 MPa to 80 MPa to the electrode precursor. As shown in Table 4, when the electronic resistance of Comparative Example 2 is determined as 100%, the relative electronic resistances of Examples 7 to 9 are from 55% to 90% and low. These results indicate that even when the insulating inorganic substance is not used, as with the results in Table 3, by applying a pressing pressure a2 of from 20 MPa to 80 MPa to the electrode precursor, both the electronic resistance at the interface between the current collector and the PTC resistor layer and the electronic resistance at the interface between the electrode active material layer and the PTC resistor layer, are decreased.

From the above results, it was revealed that the electrode for solid-state batteries which comprises the PTC resistor layer and in which electronic resistance at normal temperature is low, is obtained by increasing the pressing pressure b larger than the pressing pressure a1 (the first embodiment) or increasing the pressing pressure b larger than the pressing pressure a2 (the second embodiment) in the production method of the disclosed embodiments.

### REFERENCE SIGNS LIST

1. PTC resistor layer
2. Current collector
2′. Metal foil made of the same material as the current collector
3. Electrode active material layer
4. Resistance measuring device
5. Cathode
6. Anode
7. Electrolyte layer
10. Electrode for solid-state batteries
100. Solid-state battery
100′. Battery member
200. Confining member
300. Solid-state battery comprising the battery member and the confining member

1. A method for producing an electrode for solid-state batteries,
wherein the method is a method for producing an electrode for use in a solid-state battery comprising a cathode, an anode and an electrolyte layer disposed between the cathode and the anode;
wherein the electrode is at least one of the cathode and the anode, and the electrode comprises a current collector, an electrode active material layer and a PTC resistor layer disposed between the current collector and the electrode active material layer;
wherein the production method comprises:
forming the PTC resistor layer by applying a slurry containing an electroconductive material and a polymer to at least one of both surfaces of the current collector and drying the applied slurry,
pressing the current collector on which the PTC resistor layer is formed, at a maximum pressure a1 (pressing A1),
pressing an electrode active material member comprising at least the electrode active material layer and excluding the PTC resistor layer, at a maximum pressure b (pressing B), and
obtaining the electrode for solid-state batteries by laminating the current collector on which the PTC resistor layer is formed and the electrode active material member so that the PTC resistor layer and the electrode active material layer are in contact with each other; and
wherein the maximum pressure applied in the pressing B and the maximum pressure applied in the pressing A1 satisfy the following relation: b>a1.

2. The method for producing the electrode for solid-state batteries according to claim 1, wherein the maximum pressure a1 is from 199 MPa to 795 MPa.

3. A method for producing an electrode for solid-state batteries,
wherein the method is a method for producing an electrode for use in a solid-state battery comprising a cathode, an anode and an electrolyte layer disposed between the cathode and the anode;
wherein the electrode is at least one of the cathode and the anode, and the electrode comprises a current collector, an electrode active material layer and a PTC resistor layer disposed between the current collector and the electrode active material layer;
wherein the production, method comprises:
forming the PTC resistor layer by applying a slurry containing an electroconductive material and a polymer to at least one of both surfaces of the current collector and drying the applied slurry,
pressing an electrode active material member comprising at least the electrode active material layer and excluding the PTC resistor layer, at a maximum pressure b (pressing B),
obtaining an electrode precursor by laminating the current collector on which the PTC resistor layer is formed and the electrode active material member so that the PTC resistor layer and the electrode active material layer are in contact with each other, and
pressing the electrode precursor at a maximum pressure a2 to obtain the electrode for solid-state batteries (pressing A2); and
wherein the maximum pressure applied in the pressing B and the maximum pressure applied in the pressing A2 satisfy the following relation: b>a2.

4. The method for producing the electrode for solid-state batteries according to claim 3, wherein the maximum pressure a2 is from 20 MPa to 710 MPa.

5. The method for producing the electrode for solid-state batteries according to claim 1, wherein, in the forming of the PTC resistor layer, the slurry contains an insulating inorganic substance.

6. The method for producing the electrode for solid-state batteries according to claim 5, wherein the insulating inorganic substance is a metal oxide.

7. The method for producing the electrode for solid-state batteries according to claim 1, wherein the electroconductive material is carbon black.
